(19) United States
(12) Patent Application Publication
(10) Pub. No.: US 2025/0322061 A1
(43) Pub. Date: Oct. 16, 2025

(54) Systems and Methods for Password Management

(71) Applicant: Hongbo Zhou, Fairview, PA (US)

(72) Inventor: Hongbo Zhou, Fairview, PA (US)

(21) Appl. No.: 18/632,136

(22) Filed: Apr. 10, 2024

(51) Int. Cl. G06F 21/46; G06K 7/14

(52) U.S. Cl. CPC G06F 21/46; G06K 7/1417

(57) ABSTRACT

Systems and methods are disclosed herein for a user to use a mobile device with a camera and a terminal device with a camera to manage and use passwords via QR (Quick Response) codes. The terminal device may generate and display a QR code for a user account or data. The user running a password manager app on the mobile device may scan the QR code of the user account or the QR code of the data to generate, store, and retrieve a password, and to display a QR code for the password. The terminal device may scan the QR code of the password to receive and use the password in sign-up, sign-in, data encryption, and data decryption procedures.

### TECHNICAL FIELD

The present disclosure relates to systems and methods for management of passwords with a mobile device, based on certain hardware configurations of the mobile device and a terminal device.

### BACKGROUND

A user is usually required to input a password (or passphrase, passcode) to log into a user account on a server or a terminal device, or to open a smart lock. A password is also essential in data encryption and decryption. It is recommended that a unique password is set for each user account and each piece of data. A prevalent method of password management is a password management service running on a third-party server or cloud service. The user sets a master password for the service, which will be utilized to derive keys to encrypt other passwords and data of the user. All the encrypted passwords are stored on a server for access from any networked device. Once the user logs into the password management service with the master password, the user can retrieve and use the passwords to log into other servers, and decrypt data. However, the password management service requires constant investment in maintenance of the server or cloud service. Furthermore, a network connection is required to access the password management service. Accordingly, it is desirable to provide ways to manage passwords securely, conveniently, and cost-effectively.

### BRIEF DESCRIPTION OF THE DRAWINGS

FIG. 1 shows a system for a user to use a mobile device with a camera and a terminal device with a camera to manage and use passwords for user accounts or data. The terminal device generates and displays a QR code for a user account or data. The mobile device runs a password manager app to scan the QR code of the user account or data, to generate and store a password. The mobile device then retrieves the password, and displays a QR code for the password. The terminal device scans the QR code of the password to receive the password, and to use the password in sign-up, sign-in, data encryption, and data decryption procedures.

FIG. 2 shows a flow chart of the steps for a user to set a master password in a password manager app.

FIG. 3 shows a flow chart of the steps for a user to generate, store, and use a password for a user account in a sign-up procedure.

FIG. 4 shows a flow chart of the steps for a user to retrieve and use a password for a user account in a sign-in procedure.

FIG. 5 shows a flow chart of the steps for a user to generate, store, and use a password in a data encryption procedure.

FIG. 6 shows a flow chart of the steps for a user to retrieve and use a password in a data decryption procedure.

### DETAILED DESCRIPTION

Systems and methods are disclosed herein for a user to use a mobile device equipped with a camera and a terminal device equipped with a camera to manage and use a password in a sign-up process and a sign-in process via QR codes. A user is required to input a username and a password of a user account to access data or services on the terminal device or a server. The username and password may be validated by an authentication process running on the terminal device itself or the server. The sign-up and sign-in processes may be standalone processes, or a sign-up webpage and a sign-in webpage in a web browser, respectively. The sign-up and sign-in processes may generate and display a QR code on the terminal device for the user account. A user running a password manager app (application) on the mobile device may scan the QR code of the user account. The password manager app may generate and store a password for the user account, and retrieve the password to display as a QR code on the mobile device. The sign-up and sign-in processes may use the camera of the terminal device to scan the QR code of the password to receive the password, and to use the password in sign-up and sign-in procedures, respectively.

The systems and methods disclosed herein may also be used to manage and use a password for a data encryption process and a data decryption process. The data encryption and data decryption processes may be separate processes or in a single process. The data may be files, folders, or messages. The data may be stored in the terminal device or a server. The encryption and decryption processes may generate and display a QR code of the data on the terminal device. A user running the password manager app on the mobile device may scan the QR code of the data. The password manager app may generate and store a password for the data, and retrieve the password to display as a QR code on the mobile device. The encryption and decryption processes may use the camera of the terminal device to scan the QR code of the password to receive the password, and to use the password in data encryption and data decryption procedures, respectively.

The user may choose a master password for the password manager app on the mobile device, for secure storage and retrieval of passwords of user accounts and data. Advantageously, the passwords of user accounts and data are stored and retrieved in the mobile device, which may save the cost and work of maintaining a third-party server or cloud service for a password management service. Additional security mechanisms of the mobile device (e.g., fingerprint reader, Personal Identification Number, or facial recognition) may be utilized to protect access to the passwords. Furthermore, for the sign-up and sign-in processes to access the terminal device, or the data encryption and data decryption processes on the terminal device, a network connection may not be required for the mobile device or the terminal device. A unique password with sufficient strength to withstand a brute-force attack may be generated for each user account and each piece of data, or when the user is required to update the password of the user account periodically. Moreover, the use of QR codes may make it convenient to retrieve and use passwords.

In accordance with one or more embodiments of the present disclosure, a method is disclosed. The method includes generating a code for display for a user account on a terminal device. The method also includes receiving the code on a mobile device. The method further includes generating and saving a password for the user account on the mobile device. The method further includes retrieving the password to generate a code for display on the mobile device. The method further includes receiving the password for sign-up and sign-in processes on the terminal device.

In accordance with one or more embodiments of the present disclosure, a method is disclosed. The method includes generating a code for display for data on a terminal device. The method also includes receiving the code on a mobile device. The method further includes generating and saving a password for the data on a mobile device. The method further includes retrieving the password to generate a code for display on the mobile device. The method further includes receiving the password for data encryption and data decryption processes on the terminal device.

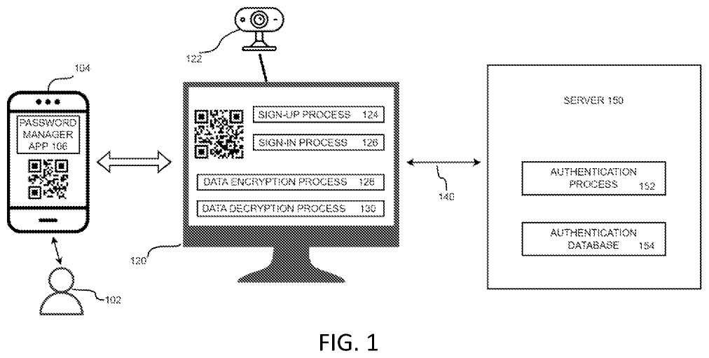

Refer now to the figures wherein the drawings are for purposes of illustrating embodiments of the present disclosure only, and not for purposes of limiting the same. FIG. 1 shows a system for a user to use a mobile device with a camera and a terminal device with a camera to manage and use passwords of user accounts and data according to one or more embodiments of the present disclosure.

A user 102 carries a mobile device with a camera 104. Mobile device with a camera 104 may be a smartphone (e.g., iPhone, Samsung Galaxy smartphone, or other smartphones running Android or other operating systems), a tablet computer (e.g., iPad, Samsung Galaxy Tab), a personal digital assistant (PDA), or various other types of mobile devices equipped with a camera. Mobile device with a camera 104 may run a password manager app 106 to manage passwords. It should be appreciated that mobile device with a camera 104 may be referred to as a mobile device without departing from the scope of the present disclosure. Password manager app 106 may be a standalone application, or a component in an operating system on mobile device 104.

In one or more embodiments, user 102 is at a terminal device 120 and wishes to sign up and sign in on a server 150. Terminal device 120 is equipped with a camera 122. Camera 122 may be a built-in camera of terminal device 120 (e.g., a laptop computer, a tablet computer), or a separate camera attached to terminal device 120 (e.g., a desktop computer with a USB webcam). Server 150 may be a web server, a file server, or a database server. Server 150 may run an authentication process 152. A link 140 is for communications between terminal device 120 and server 150. Link 140 may be a network connection.

Initially, user 102 may run a sign-up process 124 on terminal device 120 to create a user account on server 150. User 102 may choose a username and provide additional information (e.g., name, date of birth, email address). Sign-up process 124 may generate and display a QR code for the user account on terminal device 120. Password manager app 106 may scan the QR code of the user account to generate an account password. Password manager app 106 may save the account password on mobile device 104. Password manager app 106 may generate and display a QR code for the account password on mobile device 104. Sign-up process 124 may scan the QR code of the account password with camera 122 for the sign-up procedure and transmit all information to server 150 to create the user account. Authentication process 152 may save login credentials in an authentication database 154.

When user 102 wishes to sign in on server 150, user 102 may run a sign-in process 126 on terminal device 120. Sign-in process 126 may generate and display a QR code for the user account on terminal device 120. Password manager app 106 may scan the QR code of the user account to retrieve the associated account password. Password manager app 106 may generate and display a QR code for the account password on mobile device 104. Sign-in process 126 may scan the QR code of the account password with camera 122 for the sign-in procedure. Sign-in process 126 may transmit the password and additional information (e.g., the username, a token in two-factor authentication, answers to security questions) to server 150. Authentication process 152 may verify the login credentials to approve or reject the sign-in request.

In one or more embodiments, sign-up process 124 and sign-in process 126 may run on the same terminal device, or on different terminal devices.

In one or more embodiments, terminal device 120 and server 150 may be the same apparatus equipped with camera 122. User 102 wishes to sign up or sign in on terminal device 120. Terminal device 120 may be a desktop computer, a laptop computer, or a smart lock. Sign-up process 124, sign-in process 126, authentication process 152, authentication database 154 are on terminal device 120. Link 140 may be inter-process communication (IPC) between sign-up process 124, sign-in process 126, and authentication process 152. User 102 may run sign-up process 124 to create a local user account and run sign-in process 126 to gain access to terminal device 120.

In one or more embodiments, terminal device 120 and server 150 may be the same apparatus equipped with camera 122. User 102 wishes to sign up or sign in on terminal device 120. Sign-up process 124, sign-in process 126, and authentication process 152 may be in the same process. Link 140 may be internal communications within a process.

In one or more embodiments, user 102 wishes to encrypt and decrypt data on terminal device 120 equipped with camera 122. User 102 may run a data encryption process 128 to encrypt the data on terminal device 120. Data encryption process 128 may generate and display a QR code for the data on terminal device 120. Password manager app 106 may scan the QR code of the data to generate a data password. Password manager app 106 may save the data password on mobile device 104. Password manager app 106 may generate and display a QR code for the data password on mobile device 104. Data encryption process 128 may scan the QR code of the data password with camera 122 for the data encryption procedure.

When user 102 wishes to recover the data, user 102 may run a data decryption process 130 on terminal device 120. Data decryption process 130 may generate and display a QR code for the encrypted data on terminal device 120. Password manager app 106 may scan the QR code of the encrypted data to retrieve the associated data password. Password manager app 106 may generate and display a QR code for the data password on mobile device 104. Data decryption process 130 may scan the QR code of the data password with camera 122 for the data decryption procedure.

In one or more embodiments, data encryption process 128 and data decryption process 130 may run on the same terminal device, or on different terminal devices.

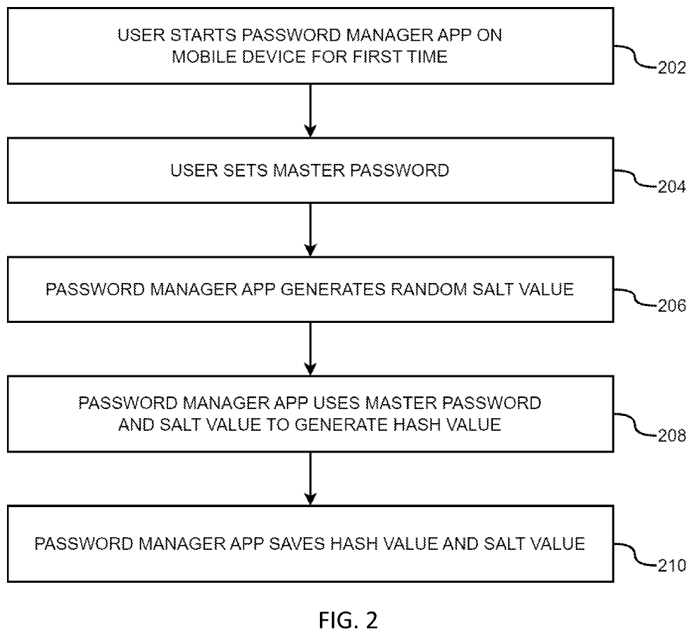

FIG. 2 shows a flow chart of steps for setting a master password in a password manager app of FIG. 1 according to one or more embodiments of the present disclosure. In 202, user 102 starts password manager app 106 on mobile device 104 for the first time. In 204, User 102 sets a master password for password manager app 106. Password manager app 106 may use a password strength checker tool to indicate the strength of the master password to user 102.

In 206, password manager app 106 generates a random salt value with a cryptographically secure pseudorandom number generator. In 208, password manager app 106 combines the master password and the salt value as an input to a cryptographic hash function to compute a hash value. The hash function may be performed for a plurality of rounds. The cryptographic hash function may be SHA-2, SHA-3, BLAKE2, or BLAKE3. In 210, password manager app 106 saves the hash value and the salt value on mobile device 104.

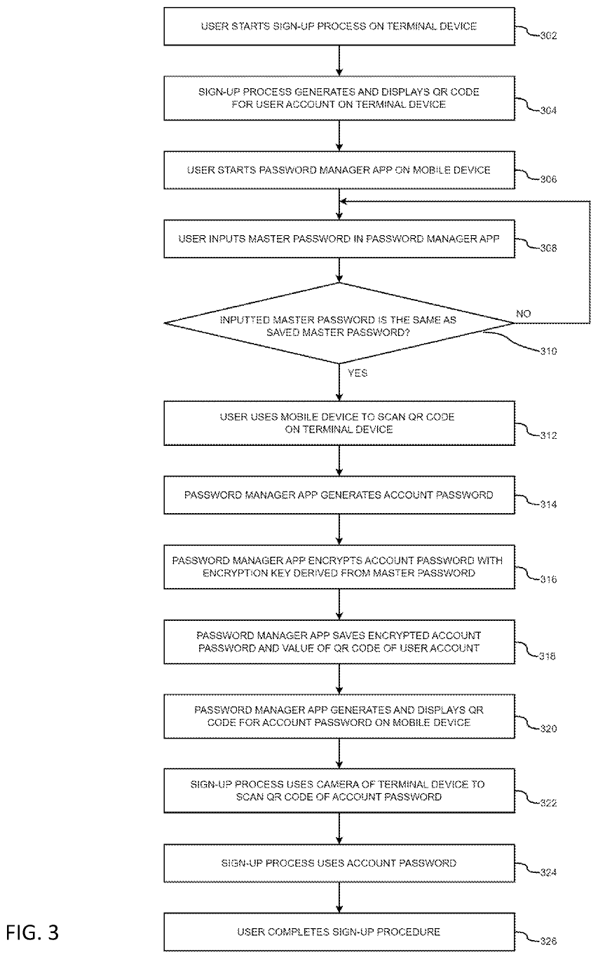

FIG. 3 shows a flow chart of steps for setting, storing, and using a password for a user account with a sign-up process and a password manager app of FIG. 1 according to one or more embodiments of the present disclosure. In 302, user 102 starts sign-up process 124 on terminal device 120. Sign-up process 124 may be a sign-up webpage in a web browser. User 102 may type a username and additional information.

In 304, sign-up process 124 generates and displays a QR code for the user account on terminal device 120. The QR code may encode a root domain name of server 150 (e.g., example.com), an Internet Protocol (IP) address of server 150 (e.g., 192.168.4.134), or a unique identifier of the user account that is generated by sign-up process 124 or server 150. The value of the QR code may be used as a key to associate with an account password for storage and retrieval on mobile device 104. The value of the QR code may be saved by authentication process 152 in authentication database 154. Sign-up process 124 may utilize a separate process to generate and display the QR code. For instance, a web browser extension may generate and display the QR code for the user account on behalf of a sign-up webpage.

In 306, user 102 starts password manager app 106 on mobile device 104. Password manager app 106 loads the salt value and the hash value of the master password saved in 210. In 308, user 102 inputs a master password in password manager app 106.

In 310, password manager app 106 verifies if the inputted master password is the same as the one chosen in 204. To perform verification, password manager app 106 combines the inputted master password and the loaded salt value as an input to the same cryptographical hash function to compute a new hash value, in the same manner as 208. Password manager app 106 then compares the new hash value with the loaded hash value. If they are not the same, password manager app 106 may ask user 102 to input the master password again. Otherwise, in 312, user 102 uses mobile device 104 to scan the QR code for the user account displayed on terminal device 120.

In 314, password manager app 106 generates a random account password with a cryptographically secure pseudorandom number generator. The account password may comprise uppercase letters, lowercase letters, digits, and special characters. In 316, password manager app 106 encrypts the account password with a symmetric-key encryption algorithm, using an encryption key derived from the master password. The symmetric-key encryption algorithm may be Advanced Encryption Standard (AES), Serpent, or Twofish. To derive the encryption key from the master password, a key derivation function (KDF) with a random salt value may be used.

In 318, password manager app 106 saves the encrypted account password and the value of the QR code of the user account on mobile device 104, to associate the account password with the user account. Password manager app 106 may save additional user data (e.g., the username inputted by user 102) and other parameters used in KDF (e.g., the random salt value, the number of iterations) associated with the user account.

In 320, password manager app 106 generates and displays a QR code for the account password on mobile device 104. In 322, sign-up process 124 scans the QR code of the account password with camera 122 to receive the account password. In 324, sign-up process 124 uses the account password to fill in its sign-up user interface. Sign-up process 124 may utilize a separate process to scan the QR code to receive and use the password. For instance, a web browser extension may scan the QR code of the account password and fill in a sign-up webpage.

In 326, user 102 completes the sign-up procedure. Sign-up process 124 transmits user data to server 150 to create the user account. Authentication process 152 receives the login credentials and saves them in authentication database 154.

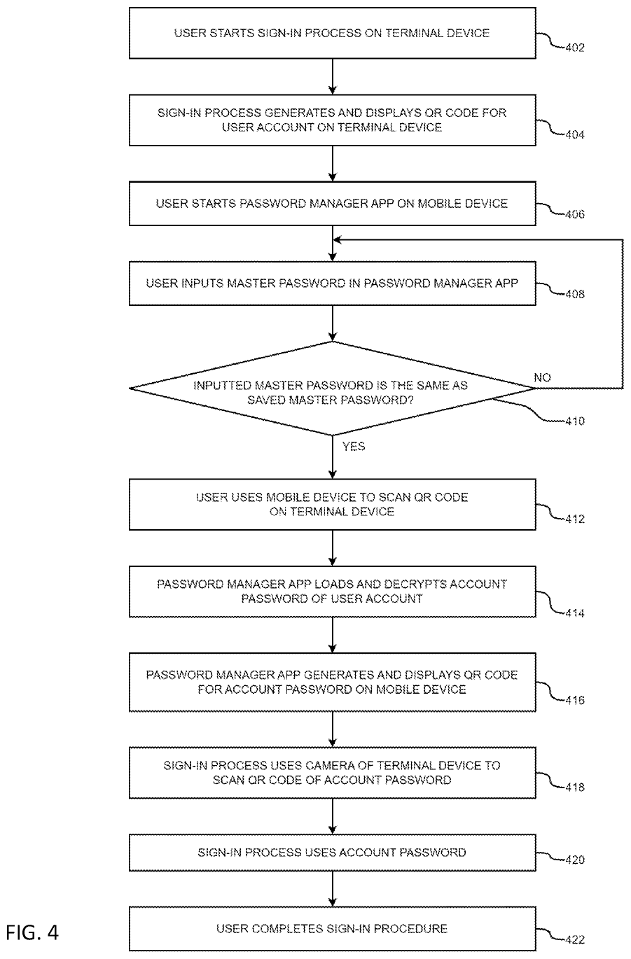

FIG. 4 shows a flow chart of steps for retrieving and using a password for a user account with a sign-in process and a password manager app of FIG. 1 according to one or more embodiments of the present disclosure. In 402, user 102 starts sign-in process 126 on terminal device 120. Sign-in process 126 may be a sign-in webpage in a web browser. User 102 may type a username and additional information. In 404, sign-in process 126 generates and displays a QR code for the user account on terminal device 120. The QR code may encode a root domain name of server 150, an IP address of server 150, or the unique identifier of the user account that is loaded from authentication database 154. Sign-in process 126 may utilize a separate process to generate and display the QR code.

In 406, user 102 starts password manager app 106 on mobile device 104. Password manager app 106 loads the salt value and the hash value of the master password saved in 210. In 408, user 102 inputs a master password in password manager app 106.

In 410, password manager app 106 verifies if the inputted master password is the same as the one chosen in 204, in the same manner as 310. If they are not the same, password manager app 106 may ask user 102 to input the master password again. Otherwise, in 412, user 102 uses mobile device 104 to scan the QR code for the user account displayed on terminal device 120.

In 414, password manager app 106 loads the encrypted account password associated with the user account saved in 318, based on the value of the QR code of the user account. Password manager app 106 may load additional information (e.g., the salt value used in KDF). Password manager app 106 runs the same KDF to derive a decryption key from the master password, in the same manner as in 316. Password manager app 106 then runs the corresponding symmetric-key decryption algorithm to recover the account password.

In 416, password manager app 106 generates and displays a QR code for the account password on mobile device 104. In 418, sign-in process 126 scans the QR code of the account password with camera 122 to receive the account password. In 420, sign-in process 126 uses the account password to fill in its sign-in user interface. Sign-in process 126 may utilize a separate process to scan the QR code to receive and use the account password.

In 422, user 102 completes the sign-in procedure. Sign-in process 126 transmits login credentials to server 150. Authentication process 152 receives the login credentials and consults authentication database 154 to determine if the sign-in request is approved or rejected.

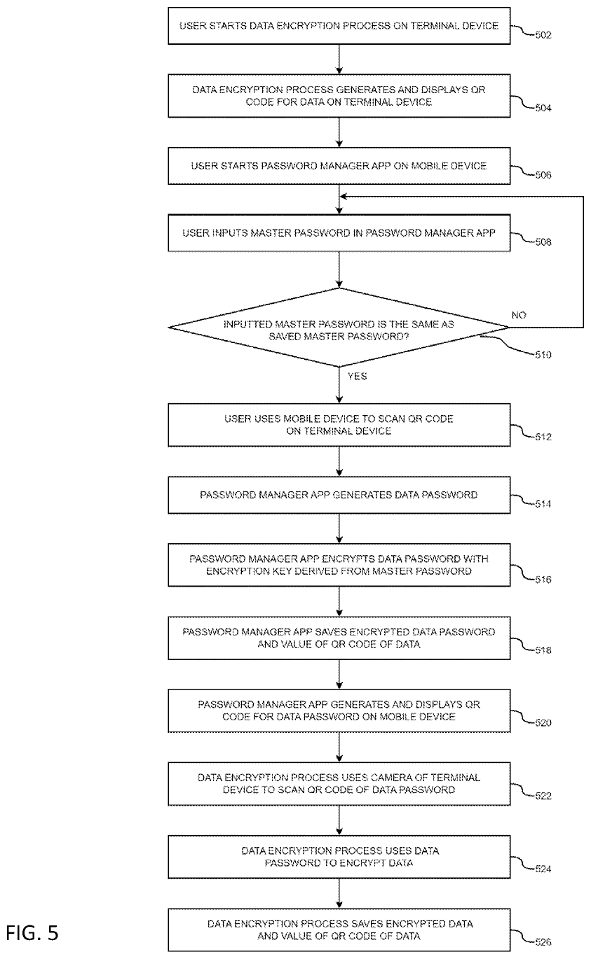

FIG. 5 shows a flow chart of steps for generating, storing, and using a password for data encryption with a data encryption process and a password manager app of FIG. 1 according to one or more embodiments of the present disclosure. In 502, user 102 starts data encryption process 128 on terminal device 120. In 504, data encryption process 128 generates and displays a QR code for the data on terminal device 120. The QR code may encode a hash value of the entire data, a hash value of a portion of the data, or a unique identifier of the data that is generated by encryption process 128. The hash value is a result of a cryptographic hash function. The value of the QR code may be used as a key to associate with a data password for storage and retrieval on mobile device 104.

In 506, user 102 starts password manager app 106 on mobile device 104. Password manager app 106 loads the salt value and the hash value of the master password saved in 210. In 508, user 102 inputs a master password in password manager app 106. In 510, password manager app 106 verifies if the inputted master password is the same as the one chosen in 204, in the same manner as 310. If they are not the same, password manager app 106 may ask user 102 to input the master password again. Otherwise, in 512, user 102 uses mobile device 104 to scan the QR code for the data displayed on terminal device 120.

In 514, password manager app 106 generates a random data password with a cryptographically secure pseudorandom number generator. The data password may comprise uppercase letters, lowercase letters, digits, and special characters. In 516, password manager app 106 encrypts the data password with an encryption key derived from the master password, in the same manner as 316. In 518, password manager app 106 saves the encrypted data password and the value of the QR code of the data on mobile device 104, to associate the data password with the data. Password manager app 106 may save other parameters used in a KDF.

In 520, password manager app 106 generates and displays a QR code for the data password on mobile device 104. In 522, data encryption process 128 scans the QR code of the data password with camera 122 to receive the data password. In 524, data encryption process 128 uses the data password for a data encryption procedure. In 526, data encryption process 128 saves the value of the QR code generated in 504 together with the encrypted data.

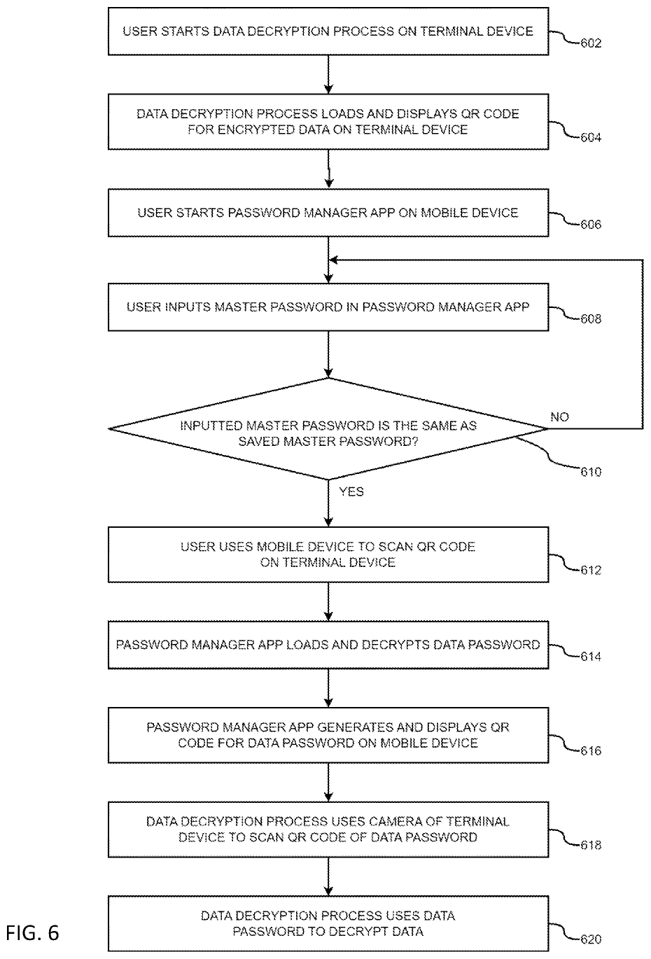

FIG. 6 shows a flow chart of steps for retrieving and using a data password for data decryption with a data decryption process and a password manager app of FIG. 1 according to one or more embodiments of the present disclosure. In 602, user 102 starts data decryption process 130 on terminal device 120. In 604, data encryption process 130 loads and displays the QR code of the value saved in 526 for the encrypted data on terminal device 120.

In 606, user 102 starts password manager app 106 on mobile device 104. Password manager app 106 loads the salt value and the hash value of the master password saved in 210. In 608, user 102 inputs a master password in password manager app 106. In 610, password manager app 106 verifies if the inputted master password is the same as the one chosen in 204, in the same manner as 310. If they are not the same, password manager app 106 may ask user 102 to input the master password again. Otherwise, in 612, user 102 uses mobile device 104 to scan the QR code for the encrypted data displayed on terminal device 120.

In 614, password manager app 106 loads the encrypted data password associated with the encrypted data saved in 518, based on the value of the QR code of the encrypted data. Password manager app 106 may load additional information (e.g., the salt value used in KDF). Password manager app 106 runs the same KDF to derive a decryption key from the master password, in the same manner as 516. Password manager app 106 then runs the corresponding symmetric-key decryption algorithm to recover the data password.

In 616, password manager app 106 generates and displays a QR code for the data password on mobile device 104. In 618, data decryption process 130 scans the QR code of the data password with camera 122 to receive the data password. In 620, data decryption process 130 uses the data password for data decryption.

When applicable, various embodiments provided by the present disclosure may be implemented using hardware, software, firmware, or combinations thereof. Application software in accordance with the present disclosure, such as computer programs executed by the mobile device to scan a QR code or to generate and display a QR code, by a processor of the terminal device to generate and display a QR code and to scan a QR code for sign-up, sign-in, data encryption, and data decryption procedures, may be stored on one or more computer readable media. It is also contemplated that the application software identified herein may be implemented using one or more general-purpose or special-purpose computers or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For instance, the QR code on a terminal device may encode additional information, such as a one-time key for secure communications between the terminal device and a mobile device. The one-time key may be generated with a cryptographically secure pseudorandom number generator. After a password manager app on the mobile device scans the QR code, the password manager app may apply the one-time key to encrypt a password, and then generate and display a QR code of the encrypted password. Once the terminal device scans the QR code of the encrypted password, it recovers the password for sign-up, sign-in, data encryption, and data decryption procedures.

It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

I claim:

1. A system comprising:
A server running an authentication process storing and validating login credentials of a user account in an authentication database, wherein the login credentials include a password; and
A terminal device with a camera running at least one of a sign-up process or a sign-in process, or a combination thereof; and
A mobile device with a camera running a password manager app to perform the steps of:
Generating a first code for display on a terminal device, wherein the first code represents a user account on a server;
Scanning the first code by a mobile device;
Generating a password for the user account on the mobile device;
Storing the password on the mobile device;
Retrieving the password on the mobile device;
Generating a second code for display on the mobile device, wherein the second code encodes the password;
Scanning the second code to receive the password by the terminal device; and
Using the password in a sign-up process or a sign-in process running on the terminal device.

2. The system of claim 1, wherein said server is running on a server device different from said terminal device, and the sign-up process and the sign-in process on said terminal device are communicating with the authentication process on said server via network connections.

3. The system of claim 1, wherein said server and said terminal device are the same apparatus, and the sign-up process and the sign-in process are communicating with the authentication process via inter-process communication.

4. The system of claim 1, wherein said server and said terminal device are the same apparatus, and the sign-up process, the sign-in process, and the authentication process are in the same process, and communicating via internal communications within the process.

5. The system of claim 1, wherein said sign-up process is a sign-up webpage in a web browser, and said sign-in process is a sign-in webpage in a web browser.

6. The system of claim 1, wherein said sign-up process and said sign-in process utilize a separate process for generating and displaying said first code, and scanning said second code to receive and use the password.

7. The system of claim 1, wherein said first code and said second code are QR codes.

8. The system of claim 1, wherein said first code encodes a root domain name of the server.

9. The system of claim 1, wherein said first code encodes an Internet Protocol address of the server.

10. The system of claim 1, wherein said first code encodes a unique identifier of the user account on the server.

11. The system of claim 1, wherein said password manager app is a component of an operating system of the mobile device.

12. A system comprising:
A terminal device with a camera running at least one of a data encryption process or a data decryption process, or a combination thereof; and
A mobile device with a camera running a password manager app to perform the steps of:
Generating a first code for display on a terminal device, wherein the first code represents data;
Scanning the first code by a mobile device;
Generating a password for the data on the mobile device;
Storing the password on the mobile device;
Retrieving the password on the mobile device;
Generating a second code for display on the mobile device, wherein the second code encodes the password;
Scanning the second code to receive the password by the terminal device; and
Using the password in a data encryption process or a data decryption process on the terminal device.

13. The system of claim 12, wherein said first code and said second code are QR codes.

14. The system of claim 12, wherein said first code encodes a hash value of the data.

15. The system of claim 12, wherein said first code encodes a hash value of a portion of the data.

16. The system of claim 12, wherein said first code encodes a unique identifier of the data.

17. The system of claim 12, wherein said data encryption process and said data decryption process are in the same process.

18. The system of claim 12, wherein said password manager app is a component of an operating system of the mobile device.

19. A method comprising:
Generating a first code for display on a first device, wherein the first code represents a user account or data;
Scanning the first code by a second device;
Generating a password on the second device;
Storing the password on the second device;
Retrieving the password on the second device;
Generating a second code for display on the second device, wherein the second code encodes the password;
Scanning the second code to receive the password by the first device; and
Using the password in sign-up, sign-in, data encryption, or data decryption procedures on the first device.
